(19) United States
(12) Patent Application Publication
(10) Pub. No.: US 2026/0249733 A1
(43) Pub. Date: Aug. 27, 2026

(54) Switch-On Control or Charging Control of Energy End-Consumer Electric Devices and/or Electric Vehicles

(71) Applicant: Siemens Aktiengesellschaft, München (DE)

(72) Inventors: Johannes Weiss, Lisberg (DE); Nikolaus Regnat, München (DE); Kilian Telschig, München (DE); Johannes Wand, Göttingen (DE); Guillaume Reitzer, Sausheim (DE)

(73) Assignee: Siemens Aktiengesellschaft, München (DE)

(21) Appl. No.: 18/877,494

(22) PCT Filed: Jun. 20, 2023
(86) PCT No.: PCT/EP2023/066542

§ 371 Date: Dec. 20, 2024

(30) Foreign Application Priority Data
Jun. 24, 2022 (EP) 22180953.6

(51) Int. Cl. B60L 53/64; B60L 53/14; B60L 53/68

(52) U.S. Cl. CPC B60L 53/64; B60L 53/14; B60L 53/68

(57) ABSTRACT

Methods and systems for switch-on control or charging control of energy end-consuming electric devices. An example includes: connecting an electric device to a low-voltage grid; generating a uniquely coded consumer point identification on a grid section between an energy consumption meter and the connection point; detecting the identifier in a modulation signal; forwarding the identifier to t a control unit of the device; and sending an authorization request, either clearance to switch on to charge the electric device. A service offered by a provider connects, via an API module to the device as a client and transfers the identifier to the provider. The method automatically switches on or charges the electric device under contracted energy supply conditions for the energy cost optimization of the electric device.

### CROSS-REFERENCE TO RELATED APPLICATIONS

This application is a U.S. National Stage Application of International Application No. PCT/EP2023/066542 filed Jun. 20, 2023, which designates the United States of America, and claims priority to EP Application No. 22180953.6 filed Jun. 14, 2022, the contents of which are hereby incorporated by reference in their entirety.

### TECHNICAL FIELD

The present disclosure relates to switch-on control or charging control of energy end-consuming electric devices and/or electric vehicles

### BACKGROUND

In the past, the provision of electrical energy was ensured primarily by coal-fired, gas-fired, and/or nuclear power plants that are able to be regulated well to a necessary energy requirement. Currently, a large part of electrical energy generation is covered by renewable energies by way of solar installations and wind turbines. Even today, there are generation peaks, for example when there is a lot of wind and a lot of sun at the same time. Wind turbines are therefore being “rotated out of the wind”. The proportion of renewable energies will, however, continue to rise in the future (keywords: climate change, digitization, electromobility, etc.).

On the other hand, increasingly more mass-produced electrical products, such as electric devices and/or electric vehicles, are being used as energy consumers. The electric devices may be battery-operated devices with a rechargeable battery, such as a notebook, a tablet, smart devices, such as smartphones, smart speakers, smart watches, wireless power outlets, smart home appliances, standby functions, etc., or household appliances that are able to be operated directly at the low-voltage grid, such as a television, a washing machine, a dishwasher or an electric oven, etc., for example.

For both types of electric devices, each individual device requires very little energy for itself, but when considering all of the devices available on the market, this energy requirement can still constitute a large proportion. In addition, the battery-operated electric devices have a battery or rechargeable battery in order to continue to function even in the absence of a low-voltage grid connection.

The electric vehicles are in the low-voltage range, in particular electric cars that charge their installed energy stores, for example large charging batteries or charging rechargeable batteries, at charging stations. In this case too, each individual electric vehicle requires relatively little energy for a charging operation, but when considering all of the electric vehicles being used, and this number is likely to increase rather than decrease in the context of climate change, the energy requirement in this area will account for an even larger proportion than for the electric devices mentioned above.

In this conflict between generation peaks of renewable energies, on the one hand, and energy requirements of mass-produced electrical products (amongst other things, electric devices and/or electric vehicles) if the energy requirement of the individual electrical products is low, on the other hand, the question arises as to whether it is possible for these mass-produced electrical products mentioned to be switched on and/or charged for product operation precisely if energy is already present in the energy grid in any case?

Until now, no solution has been known that works for such mass-produced electrical products on a broad scale. There are individual solutions, for example a solution in which the charging of an electric car is controlled remotely and only permitted if there is too much electricity in the grid.

### SUMMARY

The teachings of the present disclosure include methods and control arrangements for switch-on control or charging control of energy end-consuming electric devices and/or electric vehicles, in which an electric device/electric vehicle at an energy consumption point at which the electric device/electric vehicle consumes electrical energy due to being switched on in an operating state or due to charging a battery, for example a rechargeable battery, can be controlled, for a specific purpose, for the purpose of energy cost optimization of the energy consumption, with identification of the energy consumption point for a temporary operating duration or charging duration.

For example, some embodiments include a method for switch-on control or charging control of energy end-consuming electric devices and/or electric vehicles, in which an electric device (EG) of an energy end consumer (EEV) comprising a power supply unit (NZT) that is associated with the electric device (EG) or is arranged in the electric device (EG), or an electric vehicle (EFZ) of an energy end consumer (EEV) comprising a power supply unit (NZT) that is arranged in the electric vehicle (EFZ), is able to be connected, in each case via the power supply unit (NZT), to a low-voltage grid (NSN) comprising an energy consumption meter (EVZ) by way of a grid connection point (NAS, NASD, LST), a modulation signal (MDS) is able to be modulated into the low-voltage grid (NSN), characterized by a) generating (ezg) a uniquely coded consumer point identification identifier (VSIK) as signal information of the modulation signal (MDS) on a low-voltage grid section (NSNTS) between the energy consumption meter (EVZ) and the grid connection point (NAS, NASD, LST), b) the power supply unit (NZT) detecting (ekn) the unique coding of the consumer point identification identifier (VSIK) contained in the modulation signal (MDS), c) forwarding (wtg) the consumer point identification identifier (VSIK) to a control unit (STE) of the electric device (EG) or of the electric vehicle (EFZ), d) the control unit (STE) requesting (afg), by way of an authorization request, triggered by the consumer point identification identifier (VSIK) being forwarded, either clearance to switch on (EFG) or clearance to charge (LFG) the electric device (EG) or clearance to charge (LFG) the electric vehicle (EFZ) so as to use a service, offered by a service provider (SAB) with a service provider server (SAB-SV), for optimizing costs (EK) of electric devices/electric vehicles, said service provider server (SAB-SV) being able to be connected, via an “Application Programming Interface <API>” module of the control unit (STE), to the electric device (EG) or the electric vehicle (EFZ) as a client by way of a logical communication connection (KV_{log}) according to a client-server principle, and transferring (übg) the consumer point identification identifier (VSIK) to the service provider (SAB) by way of the service provider server (SAB-SV), e) automatically switching on or charging the electric device (EG) under contracted energy supply conditions for the energy cost optimization of the electric device (EG) or automatically charging the electric vehicle (EFZ) under contracted energy supply conditions for the energy cost optimization of the electric vehicle (EFZ) if the service provider server (SAB-SV) of the service provider (SAB) has responded (atw) to the authorization request, by way of the transferred consumer point identification identifier (VSIK), with the switch-on clearance (EFG) or the charging clearance (LFG) within a time window because the energy cost optimization for the transferred consumer point identification identifier (VSIK) is provided on account of an energy supply contract (ELK) between the service provider (SAB) and an energy provider (EAB), and, otherwise, if the switch-on clearance (EFG) or the charging clearance (LFG) is not given in the time window, the electric device (EG) is switched on manually in a conventional manner or charged in a conventional manner without said energy cost optimization, or the electric vehicle (EFZ) is charged in a conventional manner without said energy cost optimization.

In some embodiments, by way of the switch-on clearance (EFG) effected with respect to the transferred consumer point identification identifier (VSIK) and the subsequent automatic switch-on of the electric device (EG), or the effected charging clearance (LFG) and the subsequent charging of the electric device (EG) or electric vehicle (EFZ), a corresponding energy consumption (EV) of the electric device (EG) or of the electric vehicle (EFZ) is recorded, the respective energy consumption (EV) is communicated via the service provider (SAB) to the energy provider (EAB), and an energy end consumer (EEV) of the recorded energy consumption (EV) is granted a discount by the energy provider (EAB) for the respectively communicated energy consumption (EV) in accordance with the contracted energy cost optimization by receiving an energy cost discount (EKR).

In some embodiments, the modulation signal (MDS) is generated at regular intervals of time.

In some embodiments, the electric device (EG) comprising the power supply unit (NZT) that is associated with the electric device (EG) is a battery-operated device (option “A <charge>”), in particular a notebook, a tablet or a smartphone, etc., and the power supply unit (NZT) is used as a separate charging device for charging a battery (BAT), e.g. a rechargeable battery, of the battery-SUBSTITUTE operated device that, for the charging, is able to be connected to a grid connection socket (NASD) as the grid connection point (NAS) (option “A <charge>”).

In some embodiments, the electric device (EG) comprising the power supply unit (NZT) that is arranged in the electric device (EG) is a household appliance (option “B <switch on>”), in particular a television, a washing machine, a dishwasher or an electric oven, etc., and the household appliance is able to be connected to a grid connection socket (NASD) as the grid connection point (NAS) (option “B <switch on>”).

In some embodiments, the electric vehicle (EFZ) comprising the power supply unit (NZT) that is arranged in the electric vehicle (EFZ) is an electric car, and the electric car is able to be connected to a charging station (LST) as the grid connection point (NAS) via the power supply unit (NZT) so as to charge a charging battery (LBAT), for example a charging rechargeable battery.

In some embodiments, the service provider (SAB) is a manufacturer of the electric device (EG) or of the electric vehicle (EFZ) and the service provider server (SAB-SV) is a server of the electric device manufacturer or electric vehicle manufacturer.

As another example, some embodiments include a control arrangement (STGA) for switch-on control or charging control of energy end-consuming electric devices and/or electric vehicles, comprising a) an electric device (EG) or an electric vehicle (EFZ) of an energy end consumer (EEV), b) a power supply unit (NZT) that is associated with the electric device (EG) or is arranged in the electric device (EG) or electric vehicle (EFZ), and via which the electric device (EG) or the electric vehicle (EFZ) is able to be connected to a low-voltage grid (NSN) comprising an energy consumption meter (EVZ) by way of a grid connection point (NAS, NASD, LST), c) a modulator (MOD), using which a modulation signal (MDS) is able to be modulated into the low-voltage grid (NSN), characterized in that d) the modulator (MOD) is arranged on a low-voltage grid section (NSNTS) between the energy consumption meter (EVZ) and the grid connection point (NAS, NASD, LST) to generate (ezg) a uniquely coded consumer point identification identifier (VSIK) as signal information of the modulation signal (MDS), e) a detection apparatus (EKE) that detects (ekn) the unique coding of the consumer point identification identifier (VSIK) contained in the modulation signal (MDS) is contained in the power supply unit (NZT), f) a control unit (STE) that is connected to the detection apparatus (EKE) of the power supply unit (NZT) and to which the consumer point identification identifier (VSIK) is forwarded (wtg) by the power supply unit (NZT) is contained in the electric device (EG) or the electric vehicle (EFZ), g) a service provider server (SAB-SV) of a service provider (SAB) that is available for use of a service, offered by the service provider (SAB), for optimizing energy costs (EK) of electric devices/electric vehicles is contained, h) the control unit (STE) contains an “Application Programming Interface <API>” module (API-M), via which the electric device (EG) or the electric vehicle (EFZ) is able to be connected to the service provider server (SAB-SV) as a client by way of a logical communication connection (KV_{log}) according to a client-server principle, and is designed in such a way that h1) the use of the energy cost optimization is requested (afg) at the service provider server (SAB-SV) by way of an authorization request, triggered by the consumer point identification identifier (VSIK) being forwarded, for either clearance to switch on (EFG) or clearance to charge (LFG) the electric device (EG) or clearance to charge (LFG) the electric vehicle (EFZ), and h2) the consumer point identification identifier (VSIK) is transferred (übg) to the service provider (SAB) by way of the service provider server (SAB-SV), i) the service provider server (SAB-SV) and the control unit (STE) are designed in such a way that the electric device (EG) is automatically switched on or charged under contracted energy supply conditions for the energy cost optimization of the electric device (EG), or the electric vehicle (EFZ) is charged under contracted energy supply conditions for the energy cost optimization of the electric vehicle (EFZ) if the service provider server (SAB-SV) of the service provider (SAB) has responded (atw) to the authorization request, by way of the transferred consumer point identification identifier (VSIK), with the switch-on clearance (EFG) or the charging clearance (LFG) within a time window because the energy cost optimization for the transferred consumer point identification identifier (VSIK) is provided on account of an energy supply contract (ELK) between the service provider (SAB) and an energy provider (EAB), and, otherwise, if the switch-on clearance (EFG) or the charging clearance (LFG) is not given in the time window, the electric device (EG) is switched on manually in a conventional manner or charged in a conventional manner without said energy cost optimization, or the electric vehicle (EFZ) is charged in a conventional manner without said energy cost optimization.

In some embodiments, the control unit (STE) contains an energy consumption measuring apparatus (EVME) and is designed in such a way that, by way of the switch-on clearance (EFG) effected with respect to the transferred consumer point identification identifier (VSIK) and the subsequent automatic switch-on of the electric device (EG), or the effected charging clearance (LFG) and the subsequent charging of the electric device (EG) or electric vehicle (EFZ), a respectively corresponding energy consumption (EV) of the electric device (EG) or of the electric vehicle (EFZ) is recorded and the respective energy consumption (EV) is communicated via the service provider (SAB) to the energy provider (EAB) such that an energy end consumer (EEV) of the recorded energy consumption (EV) is granted a discount by the energy provider (EAB) for the respectively communicated energy consumption (EV) in accordance with the contracted energy cost optimization by receiving an energy cost discount (EKR).

In some embodiments, the modulator (MOD) is designed in such a way that the modulation signal (MDS) is able to be generated at regular intervals of time.

In some embodiments, the electric device (EG) comprising the power supply unit (NZT) that is associated with the electric device (EG) is a battery-operated device (option “A <charge>”), in particular a notebook, a tablet or a smartphone, etc., and the power supply unit (NZT) is used as a separate charging device for charging a battery (BAT), e.g. a rechargeable battery, of the battery-operated device that, for the charging, is able to be connected to a grid connection socket (NASD) as the grid connection point (NAS) (option “A <charge>”).

In some embodiments, the electric device (EG) comprising the power supply unit (NZT) that is arranged in the electric device (EG) is a household appliance (option “B <switch on>”), in particular a television, a washing machine, a dishwasher or an electric oven, etc., and the household appliance is able to be connected to a grid connection socket (NASD) as the grid connection point (NAS) (option “B <switch on>”).

In some embodiments, the electric vehicle (EFZ) comprising the power supply unit (NZT) that is arranged in the electric vehicle (EFZ) is an electric car, and the electric car is able to be connected to a charging station (LST) as the grid connection point (NAS) via the power supply unit (NZT) so as to charge a charging battery (LBAT), for example a charging rechargeable battery.

In some embodiments, the service provider (SAB) is a manufacturer of the electric device (EG) or of the electric vehicle (EFZ) and the service provider server (SAB-SV) is a server of the electric device manufacturer or electric vehicle manufacturer.

As another example, some embodiments include an electric device (EG) comprising a power supply unit (NZT) that is associated with the electric device (EG) or is arranged in the electric device (EG), and wherein the electric device (EG) is able to be connected via the power supply unit (NZT) to a low-voltage grid (NSN) comprising an energy consumption meter (EVZ) by way of a grid connection point (NAS, NASD), and the power supply unit (NZT) receives a modulation signal (MDS) modulated by a modulator (MOD) in the low-voltage grid (NSN) by way of modulation, characterized by a control unit (STE), which receives a uniquely coded consumer point identification identifier (VSIK) that is generated (ezg) as signal information of the modulation signal (MDS) on a low-voltage grid section (NSNTS) between the energy consumption meter (EVZ) and the grid connection point (NAS, NASD), that is detected (ekn) in the power supply unit (NZT) with respect to the unique coding, and that is forwarded (wtg) by the power supply unit (NZT), contains an “Application Programming Interface <API>” module (API-M), via which, for use of a service, offered by a service provider (SAB) with a service provider server (SAB-SV), for optimizing energy costs (EK) of electric devices, the electric device (EG) is able to be connected to the service provider server SAB-SV as a client by way of a logical communication connection (KV_{log}) according to a client-server principle, and is designed in such a way that the use of the energy cost optimization is requested (afg) at the service provider (SAB) by way of the service provider server (SAB-SV) by way of an authorization request, triggered by the consumer point identification identifier (VSIK) being forwarded, for clearance to switch on (EFG) or clearance to charge (LFG) the electric device (EG), the consumer point identification identifier (VSIK) is transferred (übg) to the service provider (SAB) by way of the service provider server (SAB-SV), the electric device (EG) is automatically switched on or charged under contracted energy supply conditions for the energy cost optimization of the electric device (EG) if the switch-on clearance (EFG) or charging clearance (LFG) requested by way of the transferred consumer point identification identifier (VSIK) is received (atw) within a time window as a response from the service provider server (SAB-SV) of the service provider (SAB) because the energy cost optimization for the transferred consumer point identification identifier (VSIK) is provided on account of an energy supply contract (ELK) between the service provider (SAB) and an energy provider (EAB), and, otherwise, if the control unit (STE) does not receive the switch-on clearance (EFG) or the charging clearance (LFG) in the time window, the electric device (EG) is switched on manually in a conventional manner or charged in a conventional manner without said energy cost optimization.

In some embodiments, the control unit (STE) contains an energy consumption measuring apparatus (EVME) and is designed in such a way that, by way of the switch-on clearance (EFG) effected with respect to the transferred consumer point identification identifier (VSIK) and the subsequent automatic switch-on of the electric device (EG), or the effected charging clearance (LFG) and the subsequent charging of the electric device (EG), a respectively corresponding energy consumption (EV) of the electric device (EG) is recorded and the respective energy consumption (EV) is communicated via the service provider (SAB) to the energy provider (EAB) such that an energy end consumer (EEV) of the recorded energy consumption (EV) is granted a discount by the energy provider (EAB) for the respectively communicated energy consumption (EV) in accordance with the contracted energy cost optimization by receiving an energy cost discount (EKR).

As another example, some embodiments include an electric vehicle (EFZ) comprising a power supply unit (NZT) that is arranged in the electric vehicle (EFZ), and wherein the electric vehicle (EFZ) is able to be connected via the power supply unit (NZT) to a low-voltage grid (NSN) comprising an energy consumption meter (EVZ) by way of a grid connection point (NAS, LST), the power supply unit (NZT) receives a modulation signal (MDS) modulated by a modulator (MOD) in the low-voltage grid (NSN) by way of modulation, characterized by a control unit (STE), which receives a uniquely coded consumer point identification identifier (VSIK) that is generated (ezg) as signal information of the modulation signal (MDS) on a low-voltage grid section (NSNTS) between the energy consumption meter (EVZ) and the grid connection point (NAS, LST), that is detected (ekn) in the power supply unit (NZT) with respect to the unique coding, and that is forwarded (wtg) by the power supply unit (NZT), contains an “Application Programming Interface <API>” module (API-M), via which, for use of a service, offered by a service provider (SAB) with a service provider server (SAB-SV), for optimizing energy costs (EK) of electric vehicles, the electric device (EG) is able to be connected to the service provider server SAB-SV as a client by way of a logical communication connection (KV_{log}) according to a client-server principle, and is designed in such a way that the use of the energy cost optimization is requested (afg) at the service provider server (SAB-SV) by way of an authorization request, triggered by the consumer point identification identifier (VSIK) being forwarded, for clearance to charge (LFG) the electric vehicle (EFZ), the consumer point identification identifier (VSIK) is transferred (übg), the electric vehicle (EFZ) is charged under contracted energy supply conditions for the energy cost optimization of the electric vehicle (EFZ) if the charging clearance (LFG) requested by way of the transferred consumer point identification identifier (VSIK) is received (atw) within a time window as a response from the service provider server (SAB-SV) of the service provider (SAB) because the energy cost optimization for the transferred consumer point identification identifier (VSIK) is provided on account of an energy supply contract (ELK) between the service provider (SAB) and an energy provider (EAB), and, otherwise, if the control unit (STE) does not receive the charging clearance (LFG) in the time window, the electric vehicle (EFZ) is charged in a conventional manner without said energy cost optimization.

In some embodiments, the control unit (STE) contains an energy consumption measuring apparatus (EVME) and is designed in such a way that, by way of the charging clearance (LFG) effected with respect to the transferred consumer point identification identifier (VSIK) and the subsequent charging of the electric vehicle (EFZ), a respectively corresponding energy consumption (EV) of the electric vehicle (EFZ) is recorded and the respective energy consumption (EV) is communicated via the service provider (SAB) to the energy provider (EAB) such that an energy end consumer (EEV) of the recorded energy consumption (EV) is granted a discount by the energy provider (EAB) for the respectively communicated energy consumption (EV) in accordance with the contracted energy cost optimization by receiving an energy cost discount (EKR).

### BRIEF DESCRIPTION OF THE DRAWINGS

Further advantages of the teachings herein emerge from the following description of an exemplary embodiment with reference to FIGS. 1 and 2, in which:

FIG. 1 shows a control arrangement for switch-on control or charging control of energy end-consuming electric devices incorporating teachings of the present disclosure; and

FIG. 2 shows a control arrangement for charging control of energy end-consuming electric vehicles incorporating teachings of the present disclosure.

### DETAILED DESCRIPTION

In some embodiments of the teachings herein, for switch-on control or charging control of an electric device or for charging control of an electric vehicle of an energy end consumer that is able to be connected, in each case via a power supply unit, to a low-voltage grid comprising an energy consumption meter, into which a modulation signal is able to be modulated, by way of a grid connection point,
a. a uniquely coded consumer point identification identifier is generated as signal information of the modulation signal on a low-voltage grid section between the energy consumption meter and the grid connection point,
b. the unique coding of the consumer point identification identifier contained in the modulation signal is detected by the power supply unit,
c. the consumer point identification identifier is forwarded to a control unit of the electric device or of the electric vehicle,
d. the use of a service, offered by a service provider with a service provider server, for optimizing energy costs of electric devices/electric vehicles is requested by the control unit by way of an authorization request, triggered by the consumer point identification identifier being forwarded, for either clearance to switch on or clearance to charge the electric device or clearance to charge the electric vehicle, said service provider server being able to be connected, via an “Application Programming Interface <API>” module of the control unit, to the electric device or the electric vehicle as a client by way of a logical communication connection according to a client-server principle, and the consumer point identification identifier is transferred to the service provider server,
e. the service provider server of the service provider responds with the switch-on clearance or the charging clearance within a time window if the energy cost optimization is provided on account of an energy supply contract between the service provider and an energy provider, in response to which the electric device is automatically switched on or charged under contracted energy supply conditions for the energy cost optimization of the electric device, or the electric vehicle is charged under contracted energy supply conditions for the energy cost optimization of the electric vehicle,
f. otherwise, if the switch-on clearance or the charging clearance is not given in the time window, the electric device is switched on manually in a conventional manner or charged in a conventional manner without said energy cost optimization, or the electric vehicle is charged in a conventional manner without said energy cost optimization.

By way of the switch-on clearance effected with respect to the transferred consumer point identification identifier and the subsequent automatic switch-on of o the electric device, or the effected charging clearance and the subsequent charging of the electric device or electric vehicle,
1. a corresponding energy consumption of the electric device or of the electric vehicle is recorded,
2. the respective energy consumption is communicated via the service provider to the energy provider, and
3. the energy end consumer is granted a discount by the energy provider for the respectively communicated energy consumption in accordance with the contracted energy cost optimization by receiving an energy cost discount.

In this manner, the service provider, which, for example, can be a manufacturer of the electric device or electric vehicle and the service provider server can be a server of the electric device manufacturer or electric vehicle manufacturer, can also sell energy consumption at the same time as the sale of the electric device or of the electric vehicle, so to speak, with the result that the energy end consumer and buyer of the electric device or of the electric vehicle no longer have to pay for this. The aspect of energy consumption costs of the electric device or of the electric vehicle being able to be borne by the service provider or manufacturer of the electric device or electric vehicle is an interesting, unknown approach in the context relating to the invention.

A service that is comparable in principle exists in another area, the book market, where a service provider such as Amazon™ allows Kindle™ tablets to be able to download books via a mobile network without a book end customer having to worry about a mobile contract or even think about a data volume, because this is regulated for the end customer by the service provider, such as Amazon™.

In some embodiments, the modulation signal is generated at regular intervals of time. This makes it possible to react flexibly at any time with respect to the conflict between the generation peaks of renewable energies and the energy requirements of mass-produced electrical products in the case of contracted energy supply conditions for the energy cost optimization of the electrical device or of the electric vehicle.

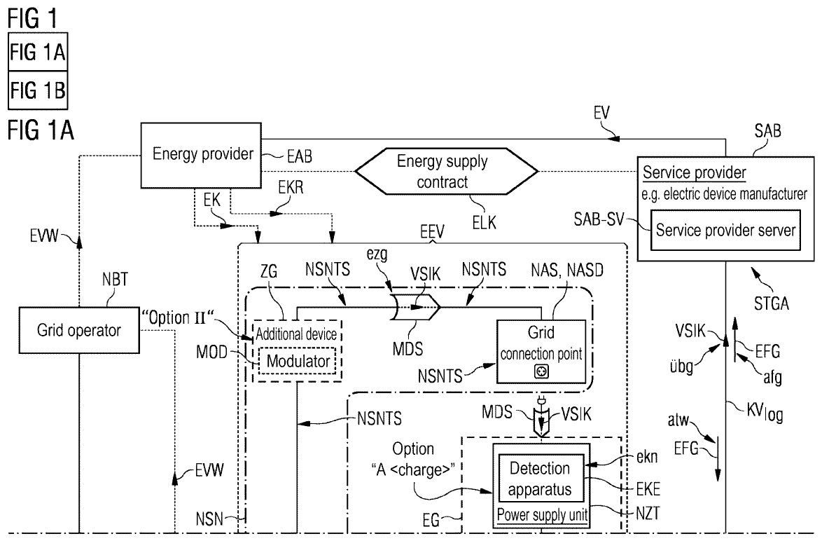

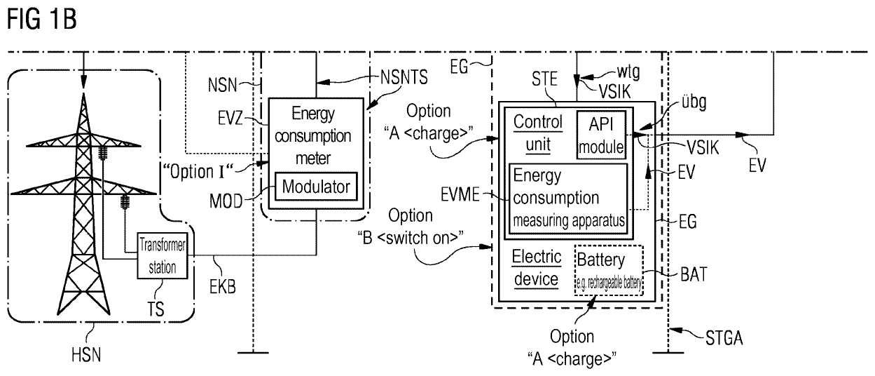

In addition, with respect to the conflict between the generation peaks of renewable energies and the energy requirements of mass-produced electrical products, the invention is advantageously distinguished by the fact that
the electric device comprising the power supply unit that is associated with the electric device is a battery-operated device (cf. option “A <charge>” in FIG. 1), for example a notebook, a tablet or a smartphone, etc., and the power supply unit is used as a separate charging device for charging a battery, e. g. a rechargeable battery, of the battery-operated device that, for the charging, is able to be connected to a grid connection socket as the grid connection point (cf. option “A <charge>” in FIG. 1),
according to Claims 5 and 12, the electric device comprising the power supply unit that is arranged in the electric device is a household appliance (cf. option “B <switch on>” in FIG. 1), for example a television, a washing machine, a dishwasher or an electric oven, etc., and the household appliance is able to be connected to a grid connection socket as the grid connection point (cf. option “B <switch on>” in FIG. 1),
the electric vehicle comprising the power supply unit that is arranged in the electric vehicle is an electric car, and the electric car is able to be connected to a charging station as the grid connection point via the power supply unit so as to charge a charging battery, for example a charging rechargeable battery.

In some embodiments, the electric device is, for example, a smartphone (smart device) with a rechargeable battery and the power supply unit is able to be connected to the grid connection socket as the grid connection point so as to charge the rechargeable battery.

The starting point for the scenario to be outlined here is the understanding of how energy costs have been calculated to date. A grid operator installs an energy consumption meter in a low-voltage grid of an energy consumption point with an energy procurement point for an energy end consumer. The energy end consumer has an energy supply contract with an energy provider and shares the corresponding energy consumption meter at the energy procurement point. The “energy consumption” of the end consumer is determined by the energy consumption meter. This must be regularly transmitted to the energy provider and the energy end consumer must pay for the energy used on the basis thereof.

The outline of the scenario comprises the following:
1. In a region of the low-voltage grid of the energy consumption point upstream or downstream of the energy procurement point for the energy end consumer, a modulation is applied to the low-voltage grid section between the energy consumption meter and the grid connection socket, which feeds a unique coded identifier, using which or on the basis of which the energy consumption point is able to be uniquely identified and which therefore is a consumer point identification identifier, into the low-voltage grid of the energy consumption point.
2. The power supply unit of the smartphone is capable of detecting the unique coded consumer point identification identifier from the low-voltage grid of the energy consumption point by virtue of it being read, for example.
3. The power supply unit forwards the detected or read consumer point identification identifier to the smartphone.
4. The smartphone queries, at a server of a service provider, for example the manufacturer of the smartphone and/or another provider, as to whether it can start a charging process for charging the rechargeable battery, and transmits the unique consumer point identification identifier to the server.
5. If a charging process is started, the smart device records the energy taken up and reports this to the service provider or manufacturer.
6. The service provider or manufacturer has a corresponding energy supply contract, or even multiple, with an energy provider in order to obtain energy from the energy provider whenever there is too much energy in the grid. For obtaining or procuring this excess energy, the service provider or manufacturer is compensated by the energy provider accordingly with a cheaper energy price for this procurement.
7. The manufacturer/provider reports to the energy provider (e. g. directly or via a grid operator) how much of the costs of the obtained or procured electrical energy are borne for which consumer point identification identifier.
8. The energy provider grants a discount to the energy end consumer accordingly; although the consumption for charging the smartphone is calculated at the energy consumption meter, the energy end consumer will be recredited with the consumption as a discount.

The components or points involved in the outlined scenario are:
A. Modulator

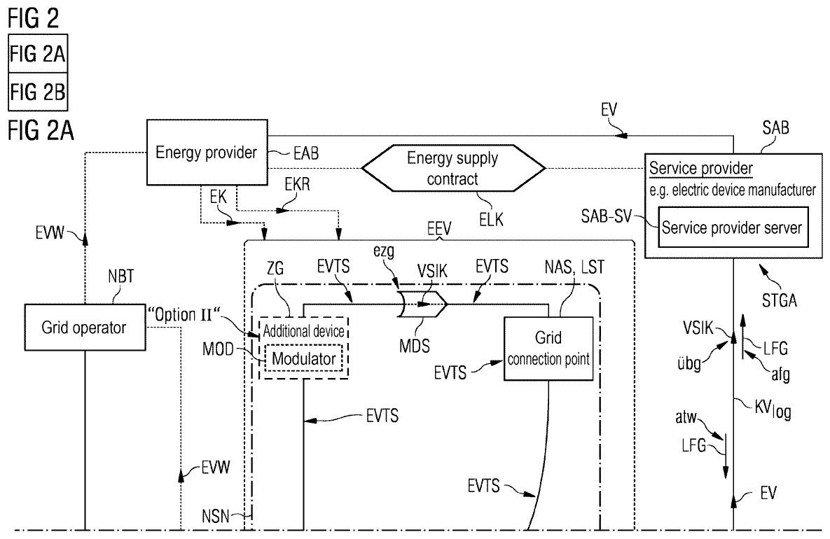

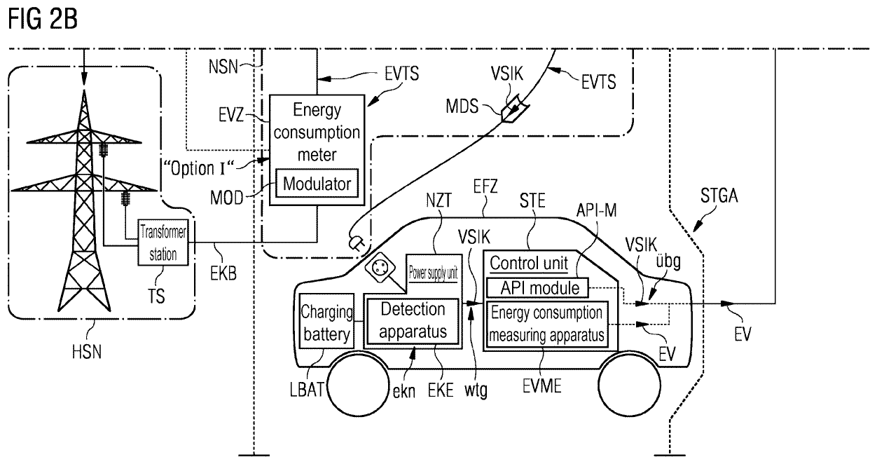

The modulator is, for example, either a function of the energy consumption meter (“option I” in FIGS. 1 and 2), i.e. in this case, the energy consumption meter has to be equipped with this function, or of an additional device (“option II” in FIGS. 1 and 2), which is installed downstream of the energy consumption meter. The modulator modulates a unique identifier as an electromagnetic signal into the low-voltage grid of the energy consumption point. This takes place by defining the corresponding frequency (for example 100 kHz) and a description (protocol) for coding the identifier, for example a preamble and then a UTF-8 <UCS (universal coded character set) transformation format> coded binary sequence of 64 characters.

The modulator itself requires a small amount of energy to modulate this signal. It obtains this via the yield of the interference from the electrical conductor, the modulator being installed in the proximity thereof. The signal itself is also again modulated onto the electrical conductor via interference (magnetic field). The modulator repeats the transmission of the identifier to the low-voltage grid of the energy consumption point at defined intervals, e.g. every minute.
B. Power supply unit

The power supply unit of the smartphone contains a function to detect the unique coding of the identifier from the low-voltage grid of the energy consumption point, e.g. above a defined frequency of, for example, 100 kHz. Following detection, the unique identifier can be forwarded to the smartphone via a USB interface.

In addition, the smartphone can instruct the power supply unit whether or not to start a charging process.

The power supply unit likewise needs a small amount of energy to detect the unique coded identifier. If the power supply unit is connected to the low-voltage grid of the energy consumption point via the grid connection socket, it is active and searches for the unique identifier until it has detected the identifier or it gives up after a certain time, for example 5 minutes. However, if the identifier has been detected, it is saved in a persistent memory. After detection or the detection task, the power supply unit goes “to sleep” until it is “woken up” by the smartphone via the USB interface.
C. Smartphone

The smartphone can read the unique identifier from the power supply unit and implements a function via an “Application Programming Interface <API>” module to communicate with the server of the service provider or manufacturer. Via the “Application Programming Interface <API>” module, the smartphone queries, at the server, as to when a charging process can be started and transfers the unique identifier to the server of the service provider or manufacturer.

The aim is to charge the rechargeable battery of the smartphone whenever there is too much energy in the grid due to renewable energies. Monitoring of this lies with the service provider or manufacturer.

If the rechargeable battery of the smartphone becomes depleted without there being a charging clearance from the service provider or manufacturer, the smartphone itself triggers the charging process via the power supply unit.

The energy taken up in the smartphone is measured and transmitted to the service provider or manufacturer.
D. Service provider or manufacturer

The service provider or the manufacturer of the smartphone can advertise the fact that the smartphone does not incur any costs during operation. The only prerequisite is that the infrastructure with the modulator is necessary. At the start, the installation of these modulators causes additional expense.

However, once installed, they can be used in a versatile manner it is a certain initial investment of the service provider or manufacturer in this sense. The aim of the service provider or manufacturer is to direct the smartphone to the charging process only if there is enough energy in the grid. To this end, the service provider or manufacturer offers negative control power, that is to say that the service provider or manufacturer receives money for procuring excess energy present in the energy grid where necessary. Where necessary, the service provider or manufacturer even receives the obtained energy without a charge and directs the smartphones to start the charging process.

The service provider or manufacturer reports to the energy provider, either directly to the energy provider or via the grid operator, specifically on the basis of the unique identifier, which energy consumption point with the energy procurement point for the energy end consumer in the low-voltage grid has “consumed” how much energy in the manner described for the scenario. The costs of this consumption are borne by the service provider or manufacturer. Ideally, this is a zero-sum game for the negative control power provided.
E. Energy provider/grid operator

The energy provider/grid operator are, in reality, two different entities to be separated from one another that have to coordinate for the scenario outlined above. They are mentioned together for the sake of simplicity, however. They also provide an “Application Programming Interface <API>” module, via which the service provider or manufacturer can report and indicate to the energy provider/grid operator how much of the energy costs at the energy consumption point should be borne. The energy provider/grid operator charges the service provider or manufacturer these costs and records a corresponding discount for the energy end consumer.

It is in the interest of the energy provider/grid operator to provide this “Application Programming Interface <API>” module for the service provider or manufacturer because, as a result, they:
can keep the proportion of renewable energies high and do not have to “remove” this generation,
the turnover of electrical energy remains constant,
energy grid stability is provided by other partners in the energy grid.

The scenario outlined above can also be applied with regard to the charging of rechargeable batteries for the electric vehicles. In addition, the scenario outlined above is also able to be applied with regard to the switching-on of electric devices without a rechargeable battery, wherein, in this case, instead of charging, switching on has to be requested and cleared.

The scenario-outlined concept of the invention, and therefore the invention, affords the advantage that
1. on the one hand, the smartphone can identify itself, and, on the other hand, specific mapping of the energy consumption can be performed on the basis of an energy supply contract with the energy provider,
2. there is the possibility for the service provider or the manufacturer of the smartphone to bear energy costs. In this way, the service provider or manufacturer can ultimately possibly even make money.

FIG. 1 shows a control arrangement STGA incorporating teachings of the present disclosure for switch-on control or charging control of energy end-consuming electric devices comprising an electric device EG of an energy end consumer EEV that forms an energy consumption point with an energy procurement point in a low-voltage grid NSN.

The low-voltage grid NSN is connected to a transformer station TS of a high-voltage grid HSN via an underground cable EKB. The high-voltage grid HSN is operated by a grid operator NBT that is in turn coupled to an energy provider EAB. In the low-voltage grid NSN, an energy consumption meter EVZ and a grid connection point NAS are arranged on a low-voltage grid section NSNTS to form the energy consumption point. The energy consumption meter EVZ records the energy consumed by the energy end consumer EEV and generates energy consumption values EVW therefrom that are provided to the energy provider EAB via the grid operator NBT as part of a PULL or PUSH mechanism. From the provided energy consumption values EVW, energy costs EK for the energy consumption recorded by the energy consumption meter EVZ are ascertained by the energy provider EAB on the basis of an energy supply contract between the energy provider EAB and the energy end consumer EEV and communicated to the energy end consumer EEV.

The electric device EG of the energy end consumer is able to be connected, for the supply of power, to the low-voltage grid NSN via the grid connection point NAS by way of a power supply unit NZT that either—as design variant 1—is associated with the electric device EG as a separate device or—as design variant 2—is part of the electric device EG and is arranged therein. In this case, the grid connection point NAS is a grid connection socket NASD, for example.

In design variant 1, the electric device EG is a battery-operated device and accordingly has a battery BAT, for example in the form of a rechargeable battery. The power supply unit NZT, which in this case is associated as a separate device with the battery-operated electric device EG, is used to charge the battery BAT (option “A <charge>”). The battery-operated electric device EG is preferably a notebook, a tablet or a smartphone, but it can also be any other battery-operated or rechargeable battery-operated device that, for charging, is connected to the grid connection socket NASD via the power supply unit NZT in the form of a separate device.

In design variant 2, the electric device EG is a household appliance or any other electric device that is not battery-operated or rechargeable battery-operated electric device that is connected, for the supply of power, directly to the grid connection socket NASD and is only switched on for start-up (option “B <switch on>”), which is usually done manually. The electric device EG operated directly at the low-voltage grid is preferably a television, a washing machine, a dishwasher or an electric oven, but it can also be any other device operated directly at the low-voltage grid.

In order to give effect to both design variants 1 and 2 in FIG. 1, the battery BAT, on the one hand, and the electric device EG with the power supply unit NZT arranged therein are each shown as dashed rectangles.

For the switch-on control or charging control of energy end-consuming electric devices, the control arrangement STGA contains a modulator MOD in the energy consumption point of the energy end consumer EEV, using which a modulation signal MDS is able to be modulated into the low-voltage grid NSN. The modulation signal MDS is used to generate ezg, as signal information, a uniquely coded consumer point identification identifier VSIK in order to identify the energy consumption point of the energy end consumer EEV. The consumer point identification identifier VSIK is generated on the low-voltage grid section NANTS between the energy consumption meter EVZ and the grid connection point NAS or the grid connection socket NASD. The modulator MOD is preferably arranged on this section of the low-voltage grid NSN in such a way that the modulator MOD is either integrated in the energy consumption meter EVZ for cost reasons and for the sake of simplicity (option “I”) or else is accommodated in an additional device ZG installed in the section with additional installation expense (option “II”). It is, however, alternatively also possible for the modulator MOD to be able to be arranged in the grid connection point NAS or the grid connection socket NASD.

The modulator MOD is additionally designed in such a way that the modulation signal MDS with the consumer point identification identifier VSIK is able to be generated at regular intervals of time.

So that, in both design variants 1 and 2 of the device EG, the power supply unit NZT can detect the uniquely coded consumer point identification identifier VSIK when the device EG is connected to the low-voltage grid NSN with the modulation signal MDS modulated thereon and the consumer point identification identifier VSIK via the power supply unit NZT by way of the grid connection point NAS or the grid connection socket NASD, the power supply unit NZT has a detection apparatus EKE configured for this purpose and accordingly designed to detect ekn the uniquely coded consumer point identification identifier VSIK.

After the consumer point identification identifier VSIK has been detected by the detection apparatus EKE, it is forwarded wtg to a control unit STE contained in the electric device EG and connected to the detection apparatus EKE.

For the switch-on control or charging control, the control unit STE contains an “Application Programming Interface <API>” module API-M, via which, for the use of a service, offered by a service provider SAB with a service provider server SAB-SV, for optimizing the energy costs EK of the electric device EG, said electric device EG is able to be connected by way of a logical communication connection KV_{log} to the service provider server SAB-SV, in which the electric device EG functions as a client and the service provider server SAB-SV functions as a server according to a client-server principle.

The control unit STE with the “Application Programming Interface <API>” module API-M is designed in such a way that, by way of an authorization request, triggered by the consumer point identification identifier VSIK being forwarded, for clearance to switch on EFG or clearance to charge LFG the electric device EG, the use of the energy cost optimization is requested afg at the service provider server SAB-SV and the consumer point identification identifier VSIK is transferred übg to the service provider server SAB-SV.

In response to the request, the service provider server SAB-SV of the service provider SAB responds atw, by way of the logical communication connection KV_{log} and the “Application Programming Interface <API>” module API-M within a time window, if the energy cost optimization is provided on account of an energy supply contract ELK that the service provider SAB has concluded with the energy provider EAB, with the switch-on clearance EFG as part of design variant 2 of the electric device EG or with the charging clearance LFG as part of design variant 1 of the electric device EG. The time window preferably has a duration of a few seconds to one or two minutes.

Consequently—in the case of design variant 2 of the electric device EG—the electric device EG switches on automatically under contracted energy supply conditions for the energy cost optimization of the electric device EG, for example for temporary operation of the electric device EG, while—in the case of design variant 2 of the electric device EG—the electric device EG is charged under contracted energy supply conditions for the energy cost optimization of the electric device EG. The automatic switch-on or the charging is respectively caused by the control unit STE.

By way of example, the charging can take place in such a way that the electric device EG that is indeed already connected to the power supply unit NZT in the form of a separate device, but no charging current is yet flowing, automatically starts the charging process by way of the control unit STE on account of the charging clearance LFG and the battery BAT or the rechargeable battery of the electric device EG is charged by the flow of the charging current.

However, if the switch-on clearance EFG or the charging clearance LFG is not given in the time window, the electric device EG is switched on manually in a conventional manner or charged in a conventional manner without said energy cost optimization.

However, if the electric device EG is switched on or is charged, energy consumed during the temporary operation when it was switched on or energy consumed for charging the electric device EG is recorded in the electric device EG.

For this purpose, the control unit STE contains an energy consumption measuring apparatus EVME, wherein the control unit STE configured in this way is designed in such a way that, by way of the switch-on clearance EFG effected with respect to the transferred consumer point identification identifier VSIK and the subsequent automatic switch-on of the electric device EG, or the charging clearance LFG and the subsequent charging of the electric device EG, an energy consumption EV, specifying the consumed energy, of the electric device EG is recorded and the respective energy consumption EV is communicated via the “Application Programming Interface <API>” module API-M and the logical communication connection KV_{log} to the service provider SAB, wherein this forwards the communicated energy consumption EV to the energy provider EAB such that the energy end consumer EEV is granted a discount by the energy provider EAB for the respectively communicated energy consumption EV in accordance with the contracted energy cost optimization by receiving an energy cost discount EKR on the energy costs EK charged to the energy end consumer EEV.

FIG. 2 shows a control arrangement STGA for switch-on control or charging control of energy end-consuming electric devices with an electric vehicle EFZ of an energy end consumer EEV, for example the driver of the electric vehicle that forms an energy consumption point with an energy procurement point in a low-voltage grid NSN.

The low-voltage grid NSN is connected to a transformer station TS of a high-voltage grid HSN via an underground cable EKB. The high-voltage grid HSN is operated by a grid operator NBT that is in turn coupled to an energy provider EAB. In the low-voltage grid NSN, an energy consumption meter EVZ and a grid connection point NAS are arranged on a low-voltage grid section NSNTS to form the energy consumption point. The energy consumption meter EVZ records the energy consumed by the energy end consumer EEV and generates energy consumption values EVW therefrom that are provided to the energy provider EAB via the grid operator NBT as part of a PULL or PUSH mechanism. From the provided energy consumption values EVW, energy costs EK for the energy consumption recorded by the energy consumption meter EVZ are ascertained by the energy provider EAB on the basis of an energy supply contract between the energy provider EAB and the energy end consumer EEV and communicated to the energy end consumer EEV.

The electric vehicle EFZ of the energy end consumer is able to be connected, for the supply of power, to the low-voltage grid NSN via the grid connection point NAS by way of a power supply unit NZT that is arranged in the electric vehicle EFZ. In this case, the grid connection point NAS is a charging station LST for electric vehicles, for example.

The electric vehicle EFZ, as is known, has a charging battery LBAT, for example in the form of a rechargeable battery. The electric vehicle EFZ is connected to the charging station LST via the power supply unit NZT in order to charge the charging battery LBAT.

For the charging control of energy end-consuming electric vehicles, the control arrangement STGA contains a modulator MOD in the energy consumption point of the energy end consumer EEV, using which a modulation signal MDS is able to be modulated into the low-voltage grid NSN. The modulation signal MDS is used to generate ezg, as signal information, a uniquely coded consumer point identification identifier VSIK in order to identify the energy consumption point of the energy end consumer EEV. The consumer point identification identifier VSIK is generated on the low-voltage grid section NSNTS between the energy consumption meter EVZ and the grid connection point NAS or the charging station LST. The modulator MOD is preferably arranged on this section of the low-voltage grid NSN in such a way that the modulator MOD is either integrated in the energy consumption meter EVZ for cost reasons and for the sake of simplicity (option “I”) or else is accommodated in an additional device ZG installed in the section with additional installation expense (option “II”). It is, however, alternatively also possible for the modulator MOD to be able to be arranged in the grid connection point NAS or the charging station LST.

The modulator MOD is additionally designed in such a way that the modulation signal MDS with the consumer point identification identifier VSIK is able to be generated at regular intervals of time.

So that the power supply unit NZT can detect the uniquely coded consumer point identification identifier VSIK when the electric vehicle EFZ is connected to the low-voltage grid NSN with the modulation signal MDS modulated thereon and the consumer point identification identifier VSIK via the power supply unit NZT by way of the grid connection point NAS or the charging station LST, the power supply unit NZT has a detection apparatus EKE configured for this purpose and accordingly designed to detect ekn the uniquely coded consumer point identification identifier VSIK.

After the consumer point identification identifier VSIK has been detected by the detection apparatus EKE, it is forwarded wtg to a control unit STE contained in the electric vehicle EFZ and connected to the detection apparatus EKE.

For the switch-on control or charging control, the control unit STE contains an “Application Programming Interface <API>” module API-M, via which, for the use of a service, offered by a service provider SAB with a service provider server SAB-SV, for optimizing the energy costs EK of the electric vehicle EFZ, said electric vehicle EFZ is able to be connected by way of a logical communication connection KV_{log} to the service provider server SAB-SV, in which the electric vehicle EFZ functions as a client and the service provider server SAB-SV functions as a server according to a client-server principle.

The control unit STE with the “Application Programming Interface <API>” module API-M is designed in such a way that, by way of an authorization request, triggered by the consumer point identification identifier VSIK being forwarded, for clearance to switch on EFG or clearance to charge LFG the electric vehicle EFZ, the use of the energy cost optimization is requested afg at the service provider server SAB-SV and the consumer point identification identifier VSIK is transferred übg to the service provider server SAB-SV.

In response to the request, the service provider server SAB-SV of the service provider SAB responds atw, by way of the logical communication connection KV_{log} and the “Application Programming Interface <API>” module API-M within a time window, if the energy cost optimization is provided on account of an energy supply contract ELK that the service provider SAB has concluded with the energy provider EAB, with the charging clearance LFG of the electric vehicle EFZ. The time window preferably has a duration of a few seconds to one or two minutes.

Consequently, the electric vehicle EFZ is charged under contracted energy supply conditions for the energy cost optimization of the electric vehicle EFZ. The charging is caused respectively by the control unit STE.

By way of example, the charging can take place in such a way that the electric vehicle EFZ that is indeed already connected to the charging station LST via the power supply unit NZT, but no charging current is yet flowing, automatically starts the charging process by way of the control unit STE on account of the charging clearance LFG and the charging battery LBAT or the rechargeable battery of the electric vehicle EFZ is charged by the flow of the charging current.

However, if the switch-on clearance EFG or the charging clearance LFG is not given in the time window, the electric device EG is switched on manually in a conventional manner or charged in a conventional manner without said energy cost optimization.

However, if the electric vehicle EFZ is charged, energy consumed for charging the electric device EG is recorded in the electric vehicle EFZ.

For this purpose, the control unit STE contains an energy consumption measuring apparatus EVME, wherein the control unit STE configured in this way is designed in such a way that, by way of the charging clearance LFG effected with respect to the transferred consumer point identification identifier VSIK and the subsequent charging of the electric vehicle EFZ, an energy consumption EV, specifying the consumed energy, of the electric vehicle EFZ is recorded and the respective energy consumption EV is communicated via the “Application Programming Interface <API>” module API-M and the logical communication connection KV_{log} to the service provider SAB, wherein this forwards the communicated energy consumption EV to the energy provider EAB such that the energy end consumer EEV is granted a discount by the energy provider EAB for the respectively communicated energy consumption EV in accordance with the contracted energy cost optimization by receiving an energy cost discount EKR on the energy costs EK charged to the energy end consumer EEV.

What is claimed is:

1. A method for switch-on control or charging control of energy end-consuming electric devices, the method comprising:
connecting an electric device of an energy end consumer, the electric device including a power supply unit, to a low-voltage grid with an energy consumption meter by a grid connection point;
modulating a modulation signal into the low-voltage grid;
generating a uniquely coded consumer point identification identifier as signal information of the modulation signal on a low-voltage grid section between the energy consumption meter and the grid connection point;
detecting with the power supply unit the unique coding of the consumer point identification identifier in the modulation signal;
forwarding the consumer point identification identifier to a control unit of the electric device;
sending with the control unit an authorization request, triggered by the consumer point identification identifier,
either clearance to switch on to charge the electric device,
so as to use a service, offered by a service provider with a service provider server for optimizing energy costs of electric devices, said service provider server able to connect, via an “Application Programming Interface <API>” module of the control unit, to the electric device as a client by way of a logical communication connection according to a client-server principle, and transferring the consumer point identification identifier to the service provider using the service provider server;
automatically switching on or charging the electric device under contracted energy supply conditions for the energy cost optimization of the electric device if the service provider server of the service provider has responded to the authorization request, by way of the transferred consumer point identification identifier, with the switch-on clearance or the charging clearance within a time window because the energy cost optimization for the transferred consumer point identification identifier is provided on account of an energy supply contract between the service provider and an energy provider, and, otherwise, if the switch-on clearance or the charging clearance is not given in the time window, the electric device is switched on manually in a conventional manner or charged in a conventional manner without said energy cost optimization, or the electric vehicle is charged in a conventional manner without said energy cost optimization.

2. A method according to claim 1, further comprising:
recording, by way of the switch-on clearance effected with respect to the transferred consumer point identification identifier and the subsequent automatic switch-on of the electric device or the effected charging clearance and the subsequent charging of the electric device,
a corresponding energy consumption of the electric device;
communicating the respective energy consumption via the service provider to the energy provider; and
granting an energy end consumer the recorded energy consumption a discount by the energy provider for the respectively communicated energy consumption in accordance with the contracted energy cost optimization by receiving an energy cost discount.

3. A method according to claim 1, wherein
the modulation signal is generated at regular intervals of time.

4. A method according to claim 1, wherein the electric device comprises a battery-operated device, and the power supply unit is used as a separate charging device for charging a battery of the battery-operated device that, for the charging, is connected to a grid connection socket as the grid connection point.

5. A method according to claim 1, wherein the electric device comprises a household appliance connected to a grid connection socket as the grid connection point.

6. A method according to claim 1, wherein the electric device comprises an electric vehicle connected to a charging station as the grid connection point via the power supply unit so as to charge a charging battery.

7. A method according to s claim 1, wherein the service provider comprises a manufacturer of the electric device and the service provider server includes a server of the electric device manufacturer.

8. A control arrangement for switch-on control or charging control of energy end-consuming electric devices, the arrangement comprising:
a power supply unit associated with an electric device via which the electric device is able to be connected to a low-voltage grid comprising an energy consumption meter by way of a grid connection point;
a modulator providing a modulation signal into the low-voltage grid,
the modulator arranged on a low-voltage grid section between the energy consumption meter and the grid connection point to generate a uniquely coded consumer point identification identifier as signal information of the modulation signal;
a detection apparatus to detect the unique coding of the consumer point identification identifier contained in the modulation signal is contained in the power supply unit;
a control unit connected to the detection apparatus to which the consumer point identification identifier is by the power supply unit;
a service provider server available for use of a service, offered by a service provider, to optimize energy costs of electric devices;
wherein the control unit
contains an “Application Programming Interface <API>” module, via which the electric device may connected to the service provider server as a client by way of a logical communication connection according to a client-server principle, and
operates so the use of the energy cost optimization is requested at the service provider server by way of an authorization request, triggered by the consumer point identification identifier being forwarded, for either clearance to switch on or clearance to charge the electric device and
the consumer point identification identifier is transferred to the service provider by the service provider server;
the service provider server and the control unit operate so
the electric device is automatically switched on or charged under contracted energy supply conditions for the energy cost optimization of the electric device if the service provider server of the service provider has responded to the authorization request, by way of the transferred consumer point identification identifier, with the switch-on clearance or the charging clearance within a time window because the energy cost optimization for the transferred consumer point identification identifier is provided on account of an energy supply contract between the service provider and an energy provider, and, otherwise, if the switch-on clearance or the charging clearance is not given in the time window, the electric device is switched on manually in a conventional manner or charged in a conventional manner without said energy cost optimization.

9. The control arrangement according to claim 8, wherein the control unit includes an energy consumption measuring apparatus designed to, by way of the switch-on clearance effected with respect to the transferred consumer point identification identifier and the subsequent automatic switch-on of the electric device, or the effected charging clearance and the subsequent charging of the electric device, a respectively corresponding energy consumption of the electric device is recorded and the respective energy consumption is communicated via the service provider to the energy provider so the energy end consumer of the recorded energy consumption is granted a discount by the energy provider for the respectively communicated energy consumption in accordance with the contracted energy cost optimization by receiving an energy cost discount.

10. A control arrangement according to claim 8, wherein the modulator generates the modulation signal at regular intervals of time.

11. A control arrangement according to claim 8, wherein the electric device comprises a battery-operated device and the power supply unit is used as a separate charging device for charging a battery electric device that, for the charging, is able to be connected to a grid connection socket as the grid connection point.

12. A control arrangement according to claim 8, wherein the electric device comprises a household appliance connected to a grid connection socket as the grid connection point.

13. A control arrangement according to claim 8, wherein the electric device comprises as electric vehicle able to be connected to a charging station as the grid connection point via the power supply unit so as to charge a charging battery.

14. A control arrangement according to claim 8, wherein the service provider includes a manufacturer of the electric device and the service provider server includes a server of the electric device manufacturer.

15. An electric device comprising:
power supply unit;
wherein the electric device is configured to be connected via the power supply unit to a low-voltage grid comprising an energy consumption meter by way of a grid connection point; and
the power supply unit receives a modulation signal from a modulator in the low-voltage grid by way of modulation;
a control unit to receive
a uniquely coded consumer point identification identifier generated as signal information of the modulation signal on a low-voltage grid section between the energy consumption meter and the grid connection point is detected in the power supply unit with respect to the unique coding, and forwarded by the power supply unit,
contains an “Application Programming Interface <API>” module, via which, for use of a service, offered by a service provider with a service provider server for optimizing energy costs of electric devices, the electric device is configured to be connected to the service provider server as a client by way of a logical communication connection according to a client-server principle, and
wherein the use of the energy cost optimization is requested at the service provider by way of the service provider server by way of an authorization request, triggered by the consumer point identification identifier being forwarded, for clearance to switch on or clearance to charge the electric device,
the consumer point identification identifier is transferred to the service provider by way of the service provider server; and
the electric device is automatically switched on or charged under contracted energy supply conditions for the energy cost optimization of the electric device if the switch-on clearance or charging clearance requested by way of the transferred consumer point identification identifier is received within a time window as a response from the service provider server of the service provider because the energy cost optimization for the transferred consumer point identification identifier is provided on account of an energy supply contract between the service provider and an energy provider, and, otherwise, if the control unit does not receive the switch-on clearance or the charging clearance in the time window, the electric device is switched on manually in a conventional manner or charged in a conventional manner without said energy cost optimization.

16. An electric device according to claim 15, wherein the control unit contains an energy consumption measuring apparatus and is designed in such a way that, by way of the switch-on clearance effected with respect to the transferred consumer point identification identifier and the subsequent automatic switch-on of the electric device, or the effected charging clearance and the subsequent charging of the electric device, a respectively corresponding energy consumption of the electric device is recorded and the respective energy consumption is communicated via the service provider to the energy provider such that an energy end consumer of the recorded energy consumption is granted a discount by the energy provider for the respectively communicated energy consumption in accordance with the contracted energy cost optimization by receiving an energy cost discount.

17. An electric device according to claim 15, wherein the electric device comprises an electric vehicle.

18. (canceled)
